(19) United States
(12) Patent Application Publication
(10) Pub. No.: US 2007/0138315 A1
(43) Pub. Date: Jun. 21, 2007

(54) Sprayer system

(76) Inventors: Donald W. Earle JR., Wilsonville, OR (US); Arthur A. Thompson, Aurora, OR (US)

Correspondence Address: KOLISCH HARTWELL, P.C., 200 PACIFIC BUILDING, 520 SW YAMHILL STREET, PORTLAND, OR, 97204, US

(21) Appl. No.: 11/599,880

(22) Filed: Nov. 14, 2006

Related U.S. Application Data
(60) Provisional application No. 60/736,787, filed on Nov. 14, 2005.

(51) Int. Cl. A01G 27/00; A01G 25/09; B05B 9/03

(52) U.S. Cl. 239/146; 239/67; 239/68; 239/69

(57) ABSTRACT

A sprayer system for spraying liquid to fall on a desired area of ground includes a reservoir for storing a liquid and a pump adapted to draw the liquid from the reservoir. At least one operative nozzle is adapted to spray at least some of the liquid drawn from the reservoir by the pump onto the ground. A valve continuously varies the amount of the drawn liquid being supplied by the pump to the nozzle, and a flow-rate meter continuously measures the actual amount of liquid being supplied by the pump to the nozzle. A controller is operatively attached to the flow-rate meter and the valve, and includes a user input for entering a constant value corresponding to a preselected amount of liquid to be sprayer system over a preselected area. The controller is adapted to continuously determine the vehicle's rate of travel, and calculate the amount of liquid that must be supplied to the nozzle based on that rate to distribute evenly the preselected amount of liquid over the preselected area. The controller is also constructed to receive a signal from the flow-rate meter indicating the actual amount of liquid being supplied to the nozzle, to compare the calculated amount of liquid to the actual amount of liquid, and to adjust the valve automatically to vary the actual amount of liquid being supplied so that it is equal to the calculated amount of liquid that must be supplied.

### CROSS-REFERENCE TO RELATED APPLICATION

This application claims priority under 35 U.S.C. § 119(e) to U.S. Provisional Patent Application Ser. No. 60/736,787 entitled “Sprayer System” filed Nov. 14, 2005, the complete disclosure of which is herein incorporated by reference for all purposes.

### BACKGROUND AND SUMMARY OF THE INVENTION

Sprayer systems that spray a mixture of chemicals and water are commonly used in agriculture, horticulture and sports field/golf course maintenance. Typically, sprayers are mounted on or towed by vehicles, including land vehicles and aircraft.

The inventions disclosed in this application include a sprayer system with an irrigation subsystem, a marker subsystem, and support structure. Preliminarily, the irrigation and marker subsystems are described as subsystems of the sprayer system, but may also be thought of as independent irrigation and marker systems usable with desired sprayer systems. The irrigation subsystem may be configured to deliver a specified amount of liquid to a specified area of land, by automatically adjusting the flow rate of the liquid based on the vehicle's rate of travel. The marker subsystem may be configured to periodically deposit a foam marker at positions corresponding to the outer edge of the locations where the sprayer has already delivered the liquid. The support structure may be configured to: (1) securely attach to the vehicle, (2) fixedly house portions of the irrigation and marker subsystems, and (3) variably retain other portions of the irrigation and marker subsystems in a manner that enables a user to selectively direct the liquid.

Examples of sprayer systems may be found in U.S. Pat. Nos. 3,972,476; 4,266,489; 5,971,295; 6,053,427; and 6,375,089, the entire disclosures of which are herein incorporated by reference for all purposes.

### BRIEF DESCRIPTION OF THE DRAWINGS

FIGS. 1-3 show various views of a sprayer system.

FIG. 4 shows a block diagram of an irrigation subsystem from the sprayer system of FIGS. 1-3.

FIG. 5 shows a valve array from the irrigation subsystem of FIG. 4.

FIG. 6 shows a manual valve from the irrigation subsystem of FIG. 4.

FIG. 7 shows nozzle arrays from the irrigation subsystem of FIG. 4.

FIGS. 8-11 show a controller from the sprayer system of FIGS. 1-3.

FIG. 12 shows a block diagram of a marker subsystem from sprayer system of FIGS. 1-3.

FIGS. 13-25 show various views of the support structure from the sprayer system of FIGS. 1-3.

### DETAILED DESCRIPTION OF THE INVENTION

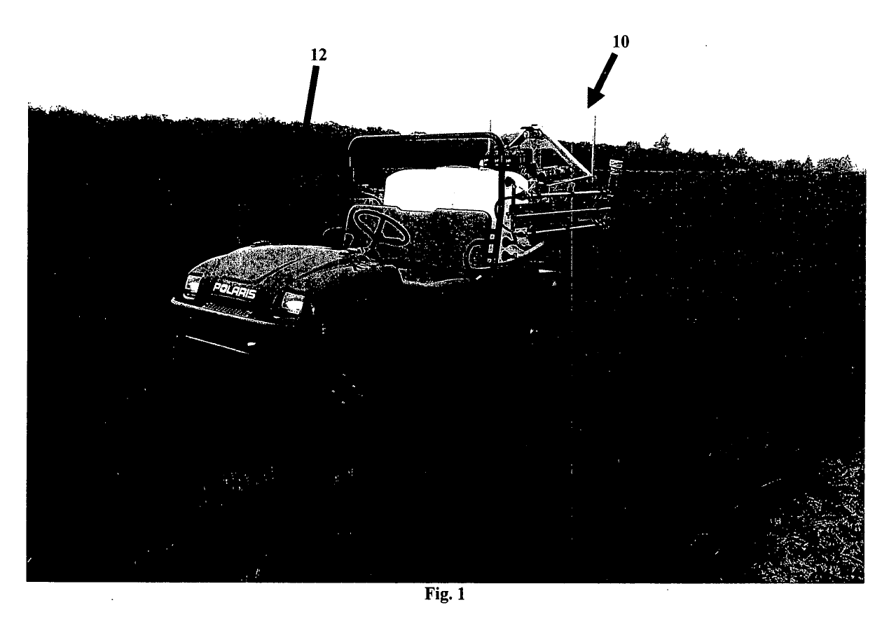

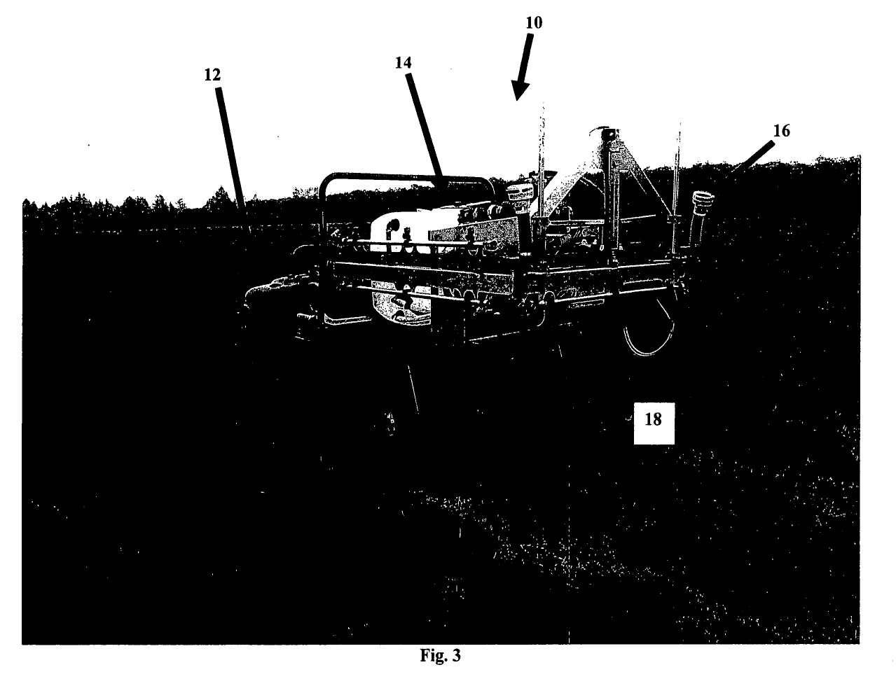

FIGS. 1-3 show a sprayer system 10 mounted to a vehicle 12. The sprayer system includes an irrigation subsystem 14, a marker subsystem 16, and a support structure 18. The irrigation subsystem is configured to accurately deliver a specified amount of liquid to a specified area, by directly determining the flow rate of the liquid as it is delivered, and automatically adjusting the liquid's flow rate based on the vehicle's rate of travel. The marker subsystem is configured to selectively deposit a foam marker (either continuously or periodically) at positions corresponding to the outer edge of the locations where the sprayer is delivering the liquid. The support structure is configured to: (1) securely attach the sprayer system to a vehicle, (2) fixedly house portions of the irrigation and marker subsystems, and (3) variably retains other portions of the irrigation and marker subsystems in a manner that enables a user to selectively direct the delivery of the liquid.

A. The Irrigation Subsystem

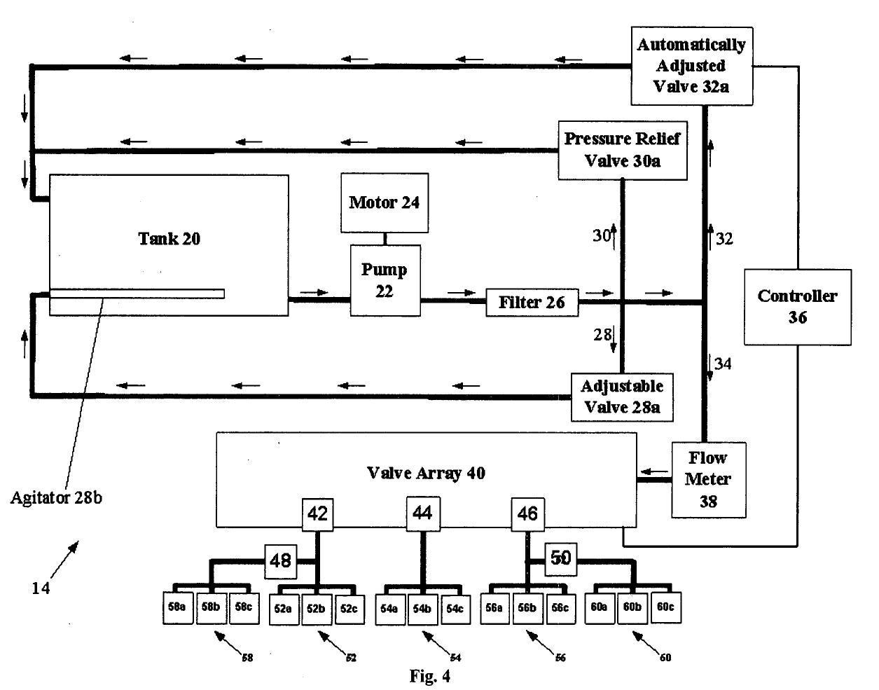

As indicated above, the irrigation subsystem 14 generally comprises any system configured to accurately deliver a specified amount of liquid to a specified area of land, by directly determining the flow rate of the liquid as it is delivered, and automatically adjusting the liquid's flow rate based on the vehicle's rate of travel. As shown in FIG. 4, the irrigation subsystem 14 may include one or more of the following: a tank 20; a pump 22 driven by a motor 24; a filter 26; an agitation subsystem 28; a pressure relief subsystem 30; a flow rate controlling subsystem 32; a liquid delivery subsystem 34; and a controller 36.

The tank 20 may be configured to store water or other liquids containing various pesticides, herbicides, fertilizers or other chemicals. The tank may come in various sizes, such as 50 gallons, 100 gallons, 200 gallons, or any other size. Than tank may be shaped to fit securely within the support structure 18, and may be made of plastic or any other suitable material.

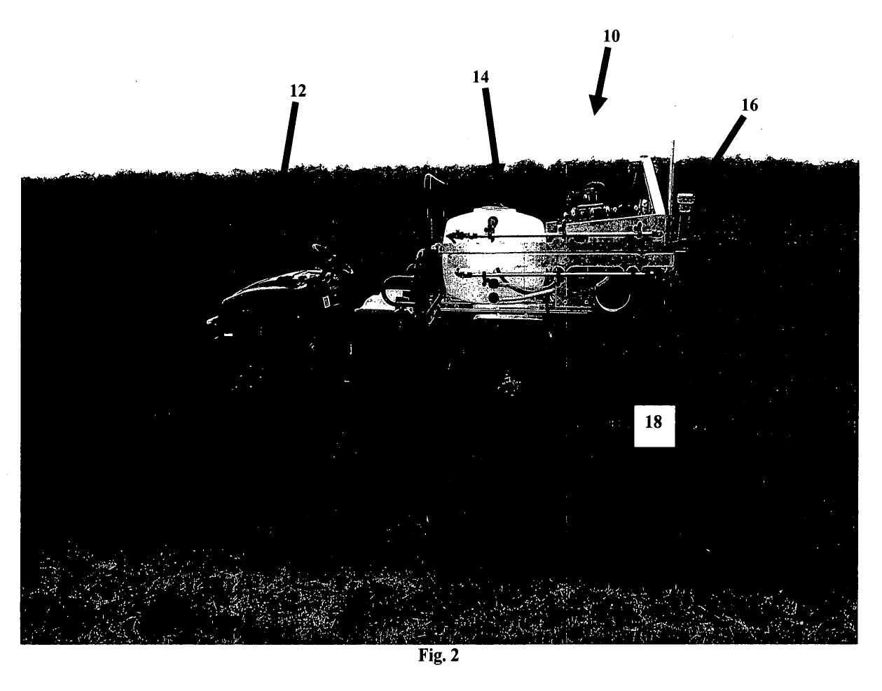

The pump 22 may be configured to draw liquid from the bottom of the tank 20 and through the rest of the irrigation subsystem 14. The pump 22 may be any type of suitable pump, such as a bent axle pump, a ball piston pump, a peristaltic pump, etc. provided it can pump a sufficient amount of liquid through the liquid delivery subsystem to accurately deliver the specified amount of liquid to the specified area of land despite variations in the vehicle's rate of travel. The pump may be connected to a motor 24 that drives the pump. The motor 24 may be any type of suitable motor for driving a pump, such as a combustion motor or a hydraulic motor that attaches to the hydraulics of the vehicle 12. Although not shown in FIG. 2, some embodiments of the irrigation subsystem may include pumps that provide variable and controllable pumping forces. Specifically, some motors may be attached to the controller, so as to drive the pump faster or slower, thereby varying the flow rate of liquid (and therefore pressure) through the irrigation subsystem.

Filter 26 may be any type of filter for removing particulate from the liquid being pumped through the irrigation subsystem 14. Specifically, the filter may be a size-exdusion filter, such as a screen mesh filter, that removes particles greater than given size. The filter thereby may be configured to prevent larger particles from interfering with, or damaging the expensive valves downstream of the pump. These types of filters need to be periodically cleaned to remove accumulated particulate, so that the system operates normally.

The agitation subsystem 28 may be configured to agitate the liquid stored in the tank, to ensure that liquid mixtures remain homogenous, and to enable crystalizable chemicals to remain in solution. Specifically, the agitation subsystem may include a manually adjustable valve 28a that selectively diverts a portion of the liquid being pumped through the irrigation subsystem 14 through an agitator 28b, and back into the bottom of the tank 20. The manually adjustable valve may be adjustable by hand, and may be configured to allow liquid at a fixed pressure to pass though the valve at a fixed flow rate. The agitator may be similar to a sparge pipe that extends some or all of the way across the tank, and includes a plurality of holes drilled throughout its length so that the liquid flowing through the agitator is dispersed throughout the tank. The liquid passing through the agitator thereby agitates, or mixes, the liquid in the tank.

The pressure relief subsystem 30 may include a pressure relief valve 30a configured to ensure that a threshold level of pressure is not exceeded within the irrigation subsystem 14. Excessive pressure may indicate that one or more of the irrigation subsystem's components has been damaged or has malfunctioned. Further, excessive pressure may cause damage to other components. The pressure relief valve may therefore be configured to open when a threshold pressure (e.g. 100 psi, 150 psi, 250 psi, 500 psi, or some other threshold pressure) is reached and/or exceeded within the system, and to divert liquid back into the tank 20 to relieve the pressure. The pressure relief valve thereby ensures that the pump 22, motor 24, flow meter 32, plumbing, and/or other components of the irrigation subsystem are not damaged by the excessive pressure.

The flow rate controlling subsystem 32 includes an automatically adjusted valve 32a that is opened or closed by the controller 36, so as to divert more or less liquid back into the tank. The valve 32a may be a butterfly valve, a solenoid valve, a servo valve, or any other suitable variable rate controllable valve. As described below, the controller automatically adjusts valve 32a based on the need for more or less liquid being diverted into the liquid delivery subsystem 34. Specifically, if the liquid delivery subsystem requires more liquid, the controller automatically closes valve 32a whereby less liquid is diverted through the flow rate controlling subsystem, and more liquid is diverted through the liquid delivery subsystem. Conversely, if the liquid delivery subsystem requires less liquid, the controller automatically opens valve 32a, whereby more liquid is diverted through the flow rate controlling subsystem, and less liquid is diverted through the liquid delivery subsystem.

The liquid delivery subsystem 24 delivers liquid out of the irrigation subsystem 14 and onto the ground. The liquid delivery subsystem may include a flow meter 38, and a valve array 40. The flow meter may be configured to directly measure the flow rate of the liquid as it passes through the liquid delivery system. For example, the flow meter may include a wheel having a plurality of magnets, and a sensor that senses the magnets as the wheel spins within the flow meter. The sensor may thereby detect the rate at which the wheel is spinning, and accurately translate this rate into the flow rate of the liquid passing through the wheel. The flow meter may also be configured to transmit a signal including the flow rate to the controller 36, whereby the controller may determine whether the flow rate is adequate to provide the correct amount of liquid to the valve array based on the vehicle's rate of travel. The controller may thereafter automatically open/close valve 32a until the flow rate through the flow meter is adequate to provide the correct amount of liquid to the valve array based on the vehicle's rate of travel.

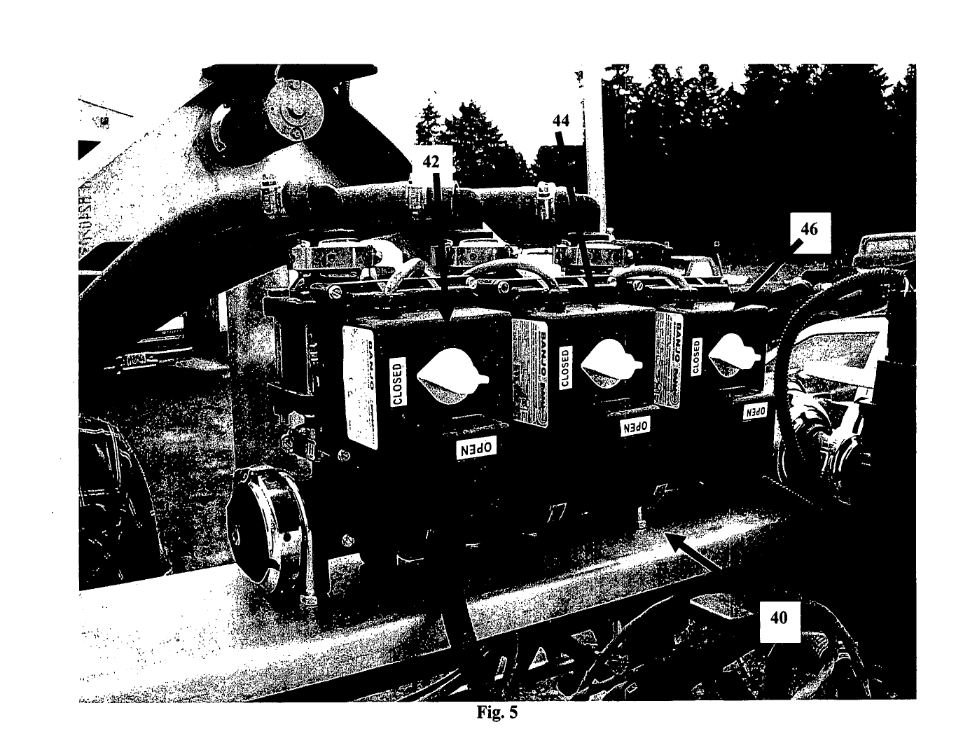

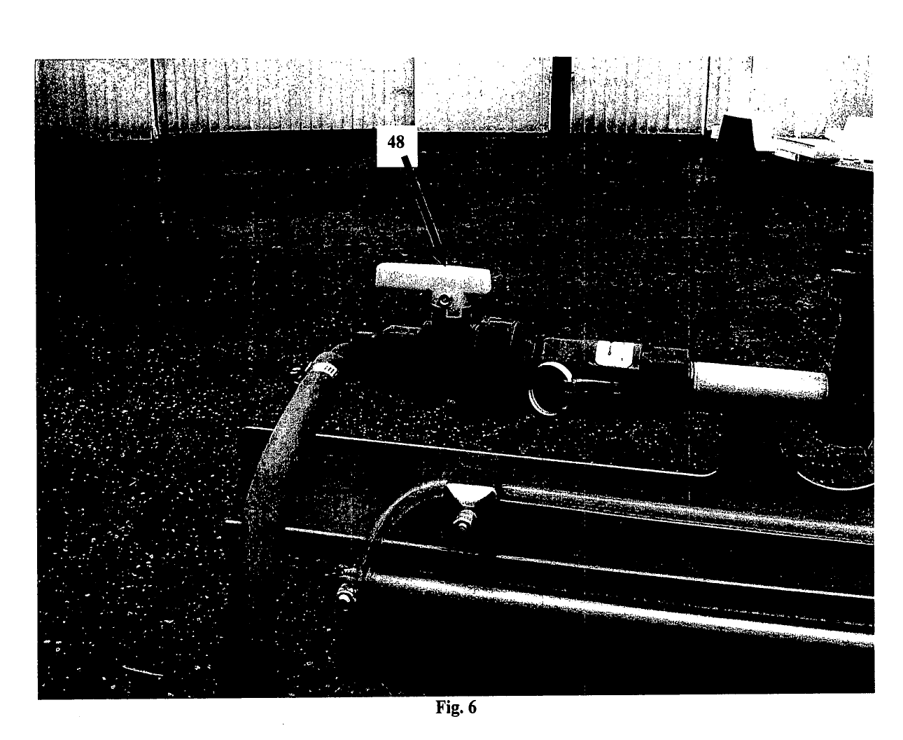

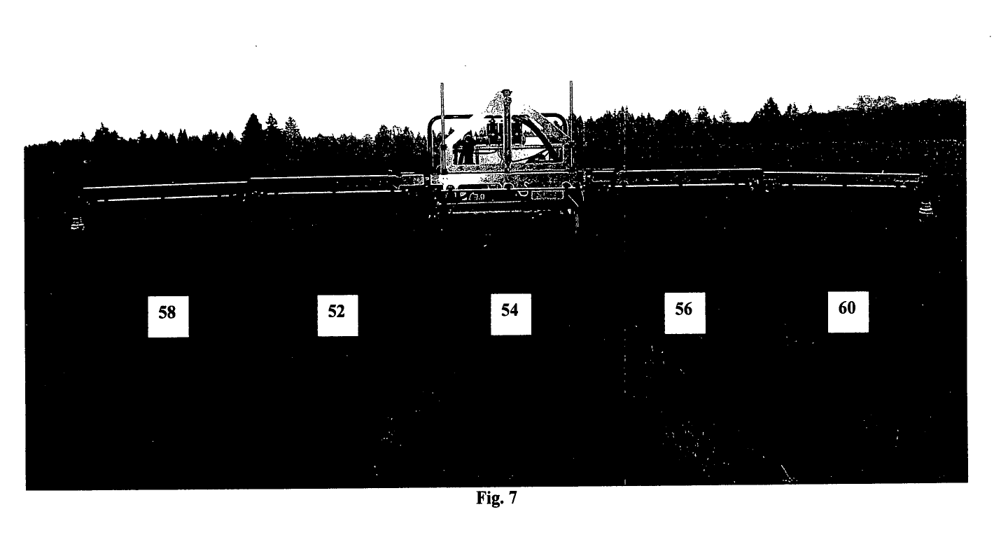

The valve array 40 may include a plurality of valves configured in parallel and/or in series to one another, where each valve selectively diverts liquid to a corresponding nozzle array when it is opened. For example, the valve array may include valves 42, 44 and 46 configured in parallel to one another, and valves 48 and 50 configured in series to valves 42 and 46, respectively. Each valve may be turned on or off. As described below, some of the valves may be turned on or off electronically by actuating a button or switch on the controller 36. Other valves may be turned on or off manually. If liquid reaches a valve that is functioning (i.e. is turned on), then the valve will divert water to a corresponding nozzle array. For example, valves 42, 44, 46, 48 and 50 may be configured to each divert water to nozzle arrays 52, 54, 56, 58 and 60 respectively. FIG. 5 shows a photograph of an exemplary valve array, with valves 42, 44 and 46 configured in parallel. FIG. 6 shows a photograph of an exemplary manual valve 48 configured in series to valve 42. FIG. 7 shows a photograph of exemplary nozzle arrays 52, 54, 56, 58 and 60.

As shown in FIGS. 4 and 7, each nozzle array may include one or more nozzles. For example, FIG. 4 shows each nozzle array 52, 54, 56, 58 and 60 having nozzles 52a-c, 54a-c, 56a-c, 58a-c, and 60a-c, respectively. Each nozzle may be positioned to deliver liquid to a different location. Therefore, in order to deliver a specific amount of liquid to a specific area, each functioning nozzle necessarily creates a demand for liquid that is proportional to the vehicle's rate. As the vehicle moves faster, each functioning nozzle requires proportionally more liquid per unit of time, and as the vehicle moves slower each functioning nozzle requires proportionally less liquid per unit of time. Likewise, each functioning nozzle array (i.e. each block of functioning nozzles) requires more or less liquid per unit time as the vehicle moves faster or slower, respectively.

The valve array 40 creates an overall demand for liquid based on (1) the vehicle's rate of travel, and (2) the number of functioning nozzle arrays (i.e. the number of functioning nozzles). For example, if the vehicle 12 is driving at 15 mph, the valve array is creating three times the demand for liquid than it would create if it were only operating at 5 mph. Also, if the sprayer system 10 is operating with three functioning nozzle arrays (and each nozzle array includes the same number of nozzles), then the valve array 40 is creating three times the demand for liquid than it would create if it were only operating with one nozzle array. Because the valve array's demand for liquid depends on the vehicle's rate of travel and the number of functioning nozzle arrays, the controller 36 must be programmed to accurately know both of these variables in order to be able to calculate the irrigation subsystem's demand for liquid. Only then can the controller 36 accurately control the supply of liquid to the valve array by adjusting valve 32a, and by measuring the flow rate through the flow meter 38.

The controller 36 enables the system to accurately deliver a specified amount of liquid to a specified area of land. Specifically, a user enters the amount of liquid they would like to deliver per unit area into the controller. The controller is then configured to: (1) calculate the demand for liquid created by the valve array 40; (2) measure the flow rate of liquid through the flow meter 38; (3) determine whether an accurate amount of liquid is being supplied to the valve array based on the demand; (4) if necessary, adjust valve 32a to cause more or less liquid to be diverted through the liquid delivery system 34; and (5) repeat the process.

In order to calculate the demand for liquid created by the valve array 40, the controller 36 must be programmed to accurately know the vehicle's rate of travel, and the number of functioning nozzle arrays, as discussed above. The vehicle's rate of travel may be determined by connecting the controller to a GPS, a radar system, the vehicle's speedometer, or any other mechanism for ascertaining the vehicle's rate, the most accurate mechanism being a GPS. In order to know the number of functioning nozzle arrays (or the number of functioning nozzles), the controller 36 may be configured to include buttons or switches that may be actuated to indicate that a nozzle array or (or nozzle) is functioning. For example, the controller may include a button or switch corresponding to each of the valves (e.g. 42, 44, 46, 48 and 50), such that if a particular valve is open, the controller knows that it is creating a demand for liquid. Further, in order to minimize human error, some valves in the valve assembly may be specifically controlled by the controller, such that in order for a valve to function, the controller must be used to open the valve, and the controller therefore “knows” that the valve is open. The controller is programmed to calculate the demand for liquid based on these variables.

The controller 36 is configured to periodically measure the flow rate of liquid through the flow meter 38 as described above. Specifically, the flow meter may periodically transmit a signal to the controller based on the flow rate of liquid through the flow meter. This signal may be analog or digital, but is generally an analog signal. Based on the measured flow and the calculated demand, the controller is programmed to determine whether an accurate amount of liquid is being supplied to the valve array based on the calculated demand. If so, then the controller is programmed to repeat the process without additional steps. However, if an inaccurate amount of liquid is being supplied to the valve array, then the controller is programmed to adjust valve 32a to adjust the liquid being diverted through the liquid delivery system 34, as described above. This process is then repeated.

If the controller 36 is unable to adjust valve 32a in a manner that accurately delivers the specified amount of liquid per unit area, then the controller may be programmed to generate a user-notifying event (i.e. a flashing signal, one or more noises, etc.), or to shut down the irrigation subsystem completely. The controller may be unable to adjust valve 32a in a manner that accurately delivers a specified amount of liquid per unit area because of various reasons. For example, the pump 32 or motor 34 may malfunction. Alternatively, the vehicle may be moving extremely fast, and the pump may be unable to deliver enough liquid to the nozzle array, even after completely closing valve 32a.

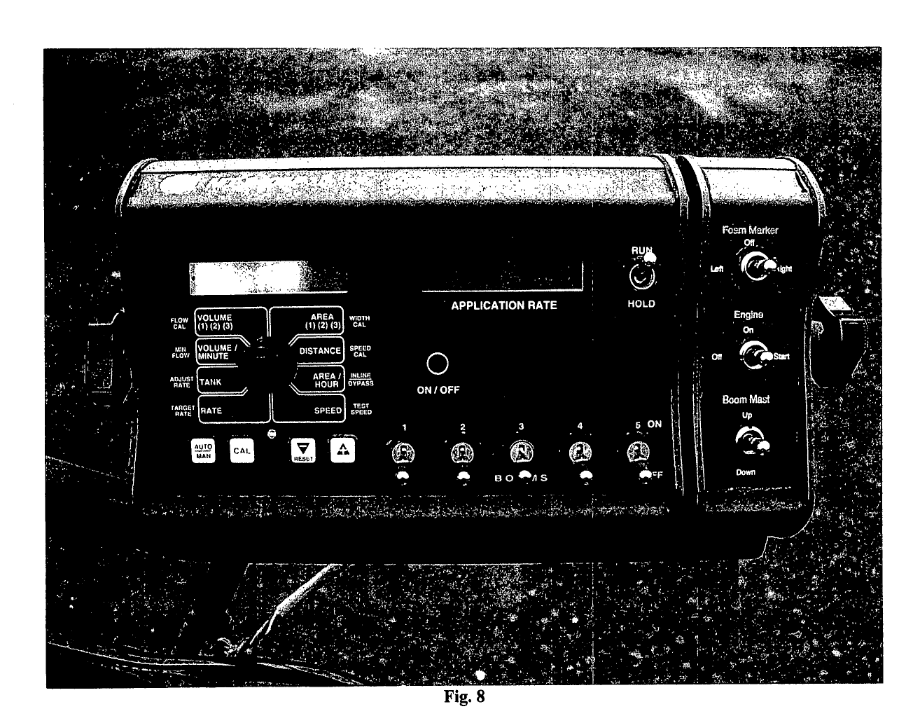

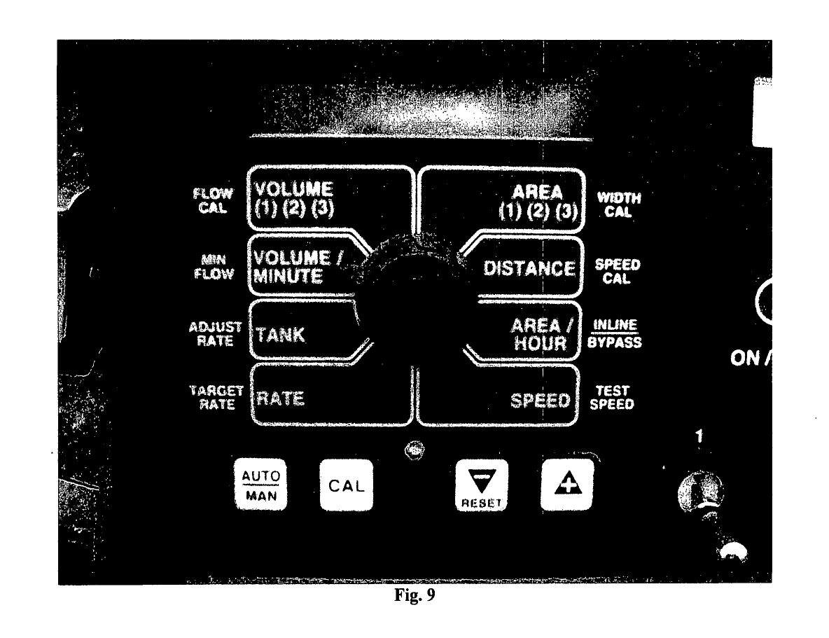

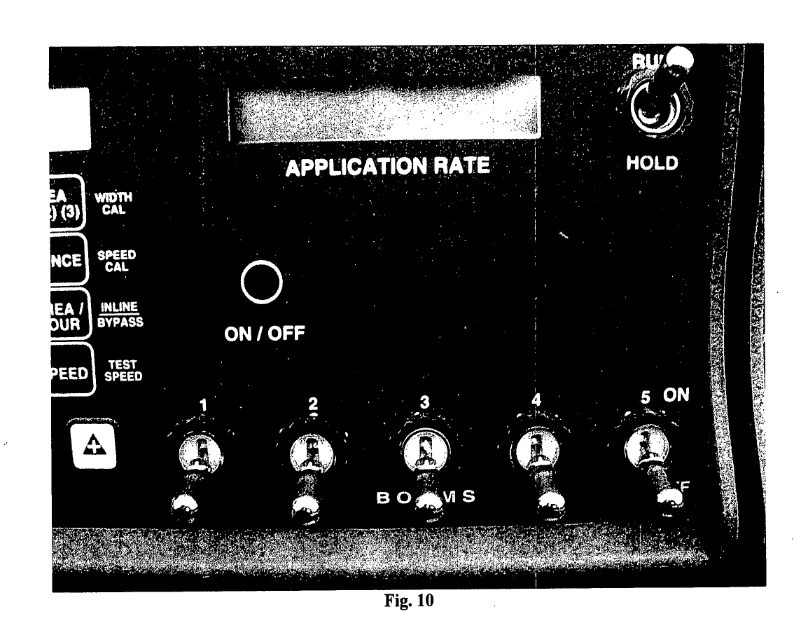

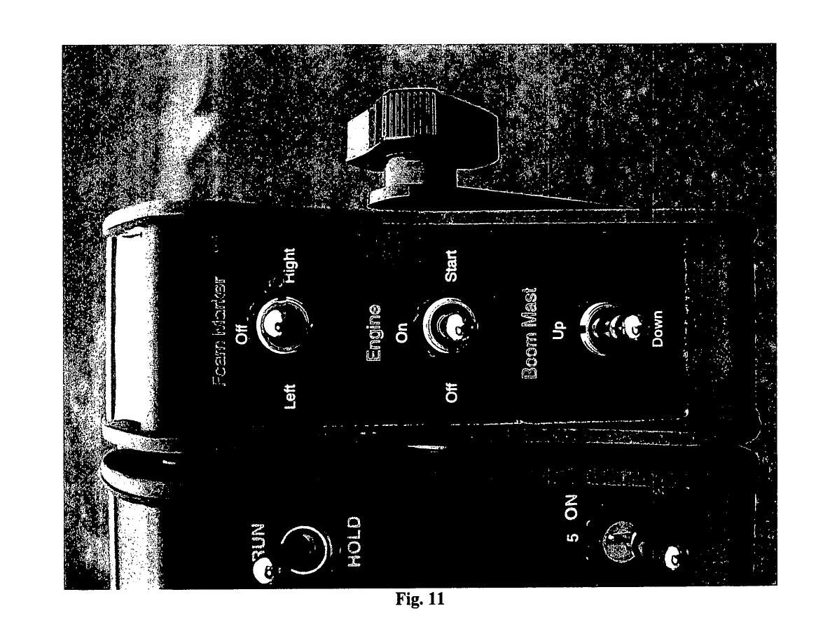

FIGS. 8-11 are photographs that generally show aspects of an exemplary controller, as described above, and below.

B. The Marking Subsystem

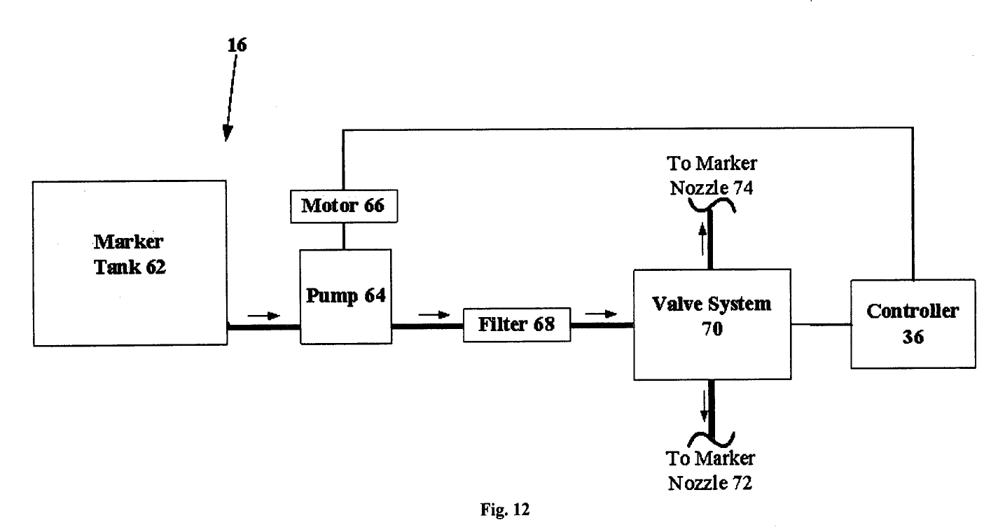

As indicated above, the marker subsystem 16 generally comprises any system configured to selectively deposit a foam marker at positions corresponding to the outer edge of the locations where the sprayer is delivering the liquid. The marker subsystem may include one or more components, and have any suitable size and shape consistent with its function. As shown in FIG. 12, the marker subsystem 16 may include one or more of the following: a tank 62; a pump 64 driven by a motor 66; a filter 68; a valve system 70 that selectively delivers foam marker to one or more marker nozzles, such as nozzle 72 and nozzle 74. The tank, pumps, motor, and filter may function in substantially the same manner as described above. The controller 36 may control the motor and/or the valve system (i.e. by actuating a button or switch) in a manner that causes the marker subsystem to either continuously or periodically deliver foam marker through the nozzles.

C. The Support Structure

As indicated above, the support structure 18 generally comprises any structure configured to (1) securely attach the sprayer system to a vehicle, (2) fixedly house portions of the irrigation and marker subsystems, and (3) variably retain other portions of the irrigation and marker subsystems in a manner that enables a user to selectively direct the delivery of the liquid. The support structure may include one or more components, and have any suitable size and shape consistent with its function.

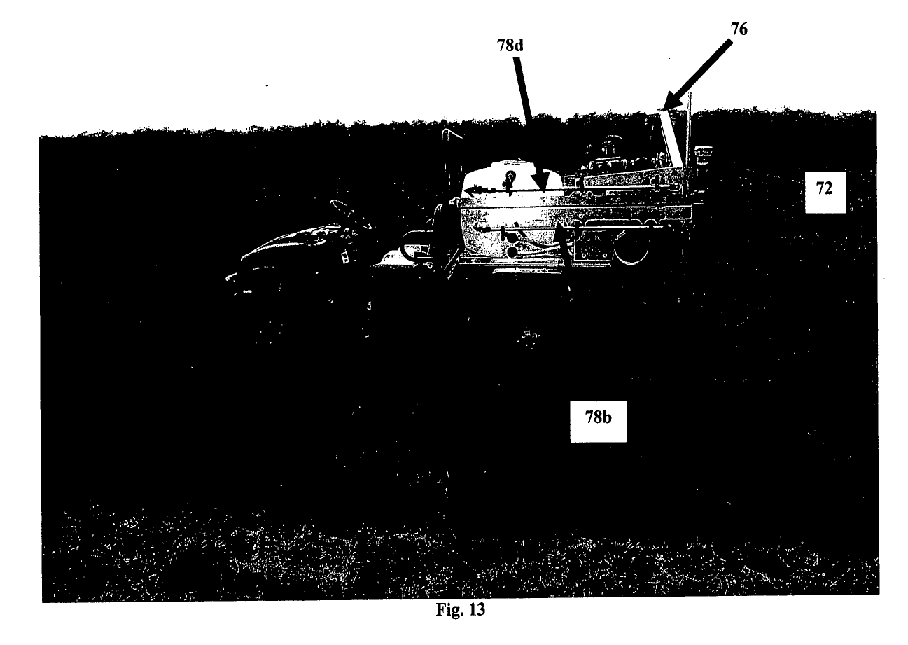

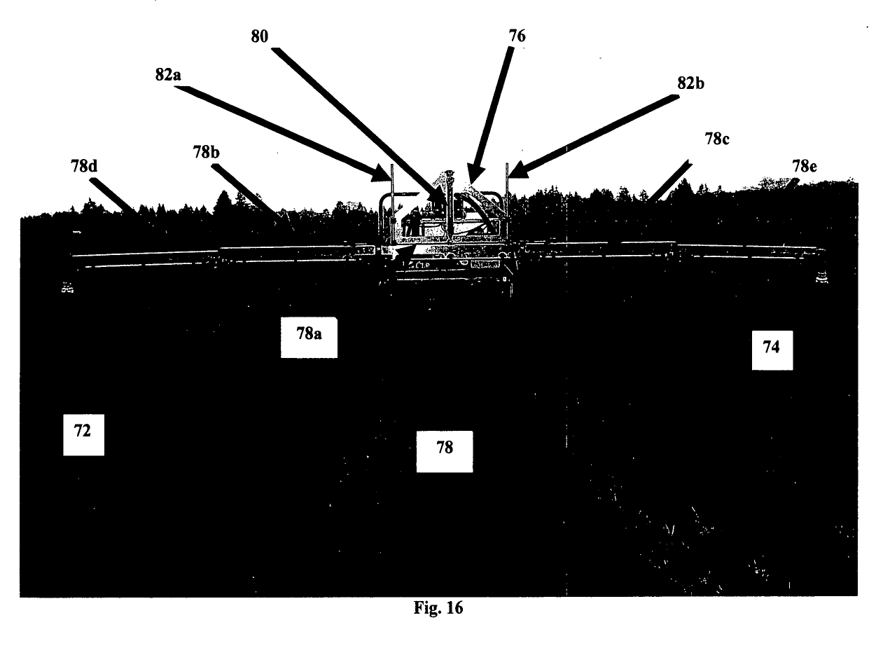

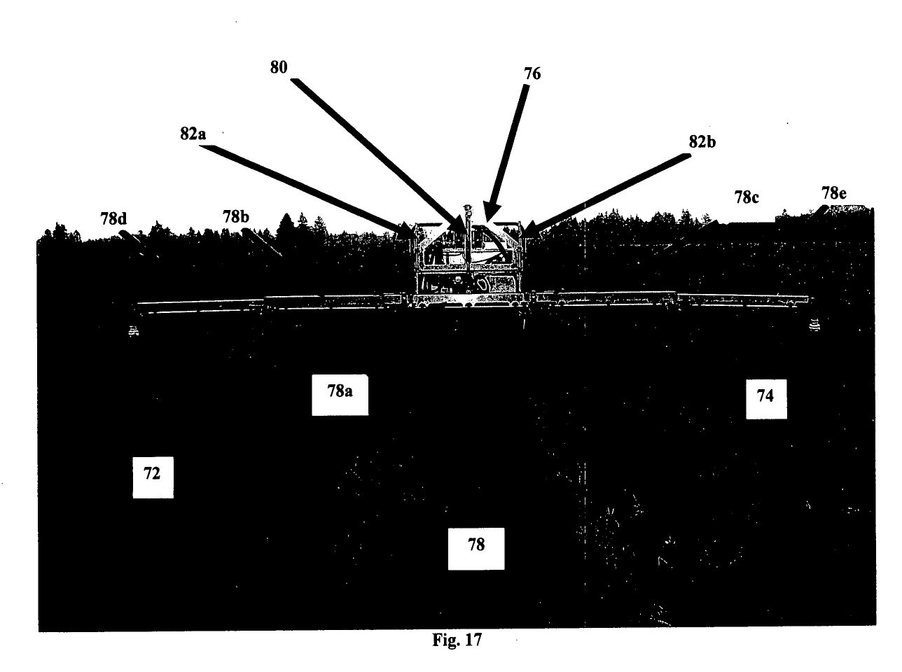

FIGS. 13-25 each show aspects of the support structure 18. As can best be seen in FIGS. 16 and 17, the support structure includes a fixed portion 76 and a boom 78. The fixed portion may be configured to securely attach the sprayer system to the vehicle, and to fixedly house portions of the irrigation and marker subsystems, such as tanks, pumps, motors, filters, and some of the valve systems or arrays. The boom may comprise a variable structure that retains and/or directs portions of the irrigation subsystem (i.e. the nozzle arrays and/or some of the irrigation subsystem's valves). The variable nature of the boom that enables a user to select the direction liquid is delivered.

As shown in FIGS. 13-18, the boom 78 may include a plurality of regions that each may be movable relative to the fixed portion 76, and/or relative to each other. Specifically, the boom may include a first region 78a, a second region 78b, a third region 78c, a fourth region 78d and/or a fifth region 78e. Each region may be configured to retain a corresponding nozzle array. As described above, each nozzle array may be supplied with liquid from a valve that is configured either in series or parallel with other valves in the irrigation subsystem 14.

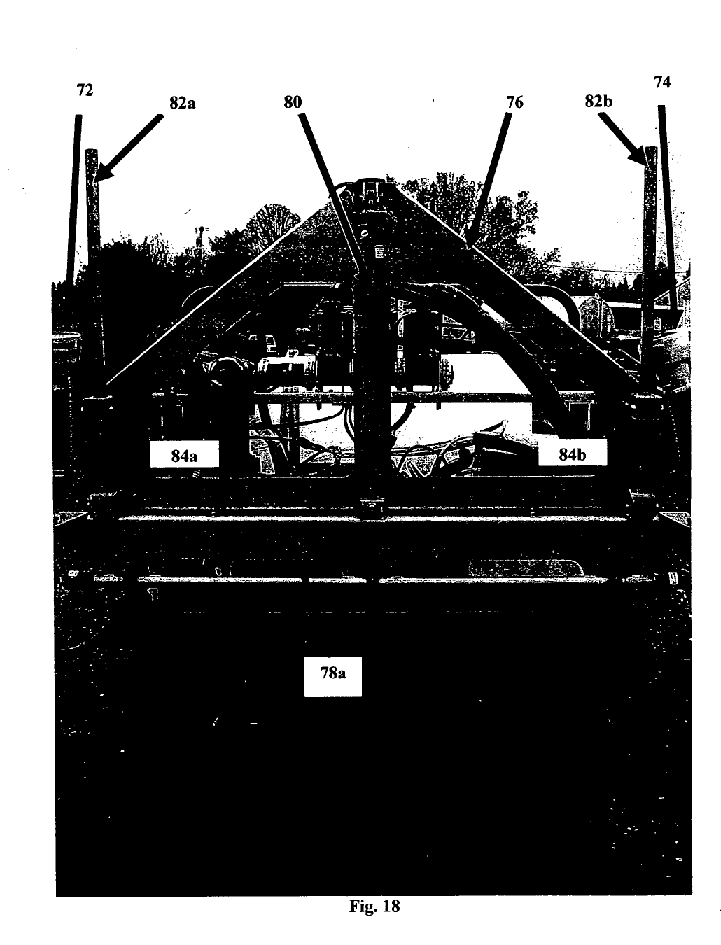

The first region 78a may be fixed adjacent to, and substantially parallel to the rear of the vehicle. As best shown in FIG. 18, the first region may be attached to the fixed portion 76 by an actuator 80. The actuator may include a hydraulic or electric piston that causes the first movable portion to raise and lower relative to the fixed portion and the ground. The actuator may be actuated by pressing a button or actuating a switch on the controller 36. The first region may also be fixedly attached to rods 82a-b, which seat snugly within guiding members 84a-b, that are fixedly attached to the fixed portion. The rods and guiding members may thereby stabilize the position of the first region (and therefore the entire boom) relative to the fixed portion during actuation of the actuator. As discussed in more detail below, the first region is also operably coupled to the second, third, fourth and fifth regions. Therefore, by raising and lower the first region, the actuator functions to raise/lower every region of the boom. FIG. 16 shows the boom fully raised by the actuator, while FIG. 17 shows the boom partially lowered by the actuator.

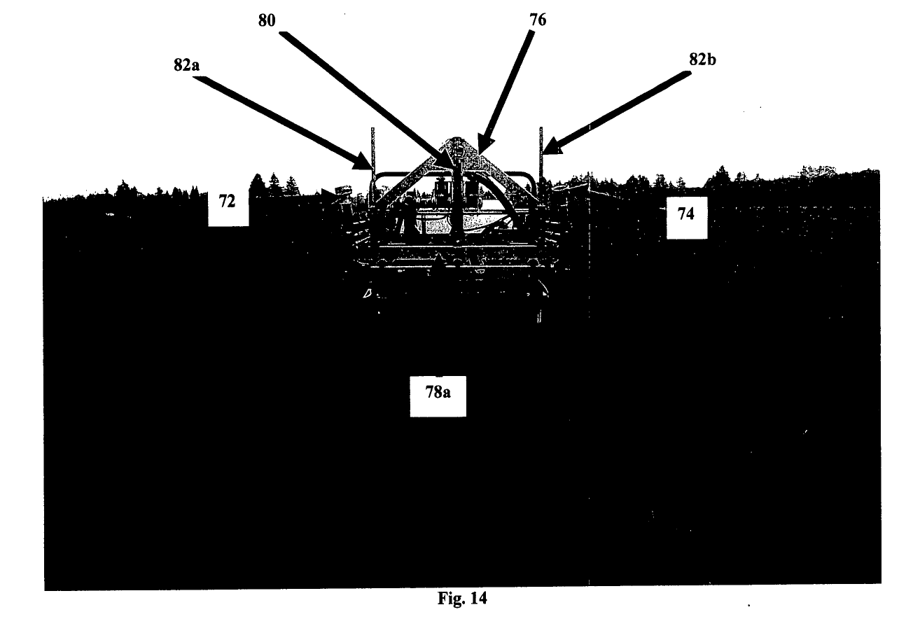

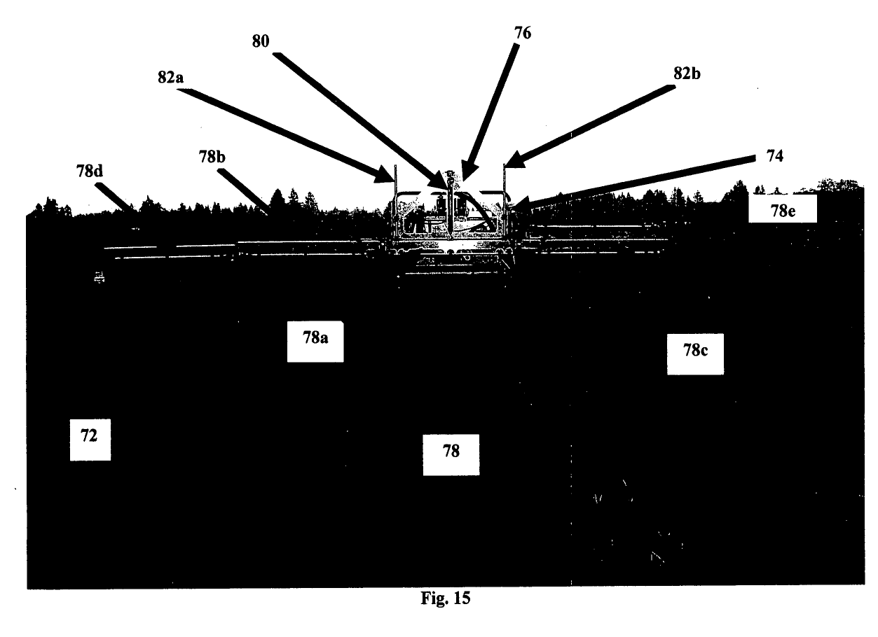

The second region 78b and third region 78c may each be pivotally attached to an end of the first region, as shown in FIGS. 13-17. The second and third regions may be configured to pivot within a horizontal plane between a stowed position, shown in FIGS. 13 and 14, and an extended position, shown in FIGS. 15-17. In the stowed position, the second and third regions may be positioned adjacent to, and substantially parallel to the side of the vehicle. In the extended position, the second and third movable portions may be positioned substantially parallel to the rear of the vehicle, and collinear with the first region, as shown in FIGS. 15-18.

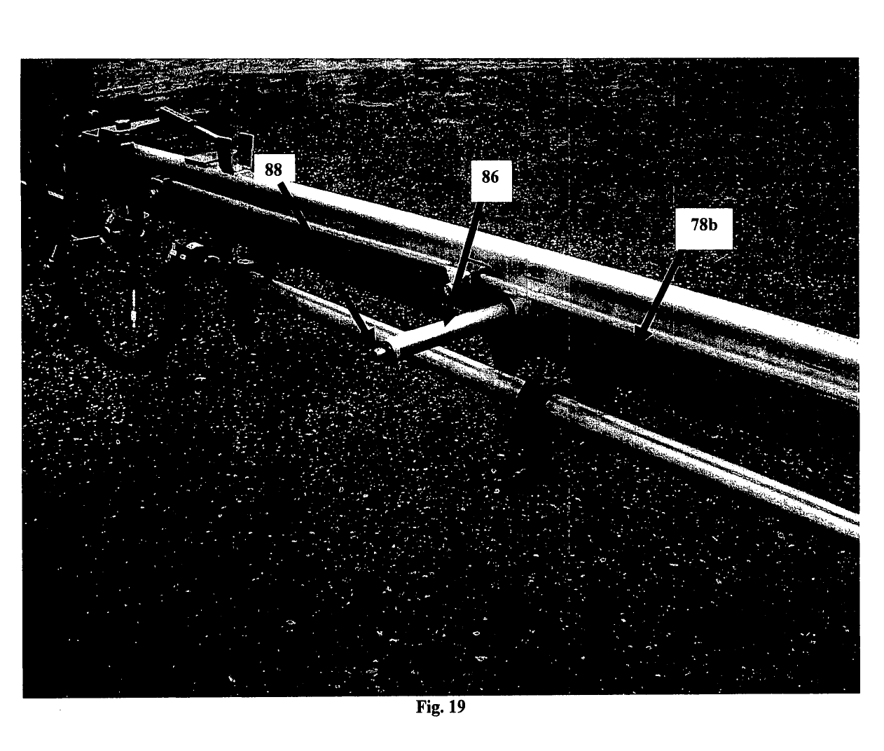

The second and third regions may each include a securing mechanism that secures the regions in the stowed positions. For example, as shown in FIG. 19, the second and third regions may each include a rod 86 with a nub 88 that fits within a hole in the side of the fixed portion, and is secured by a cotter pin.

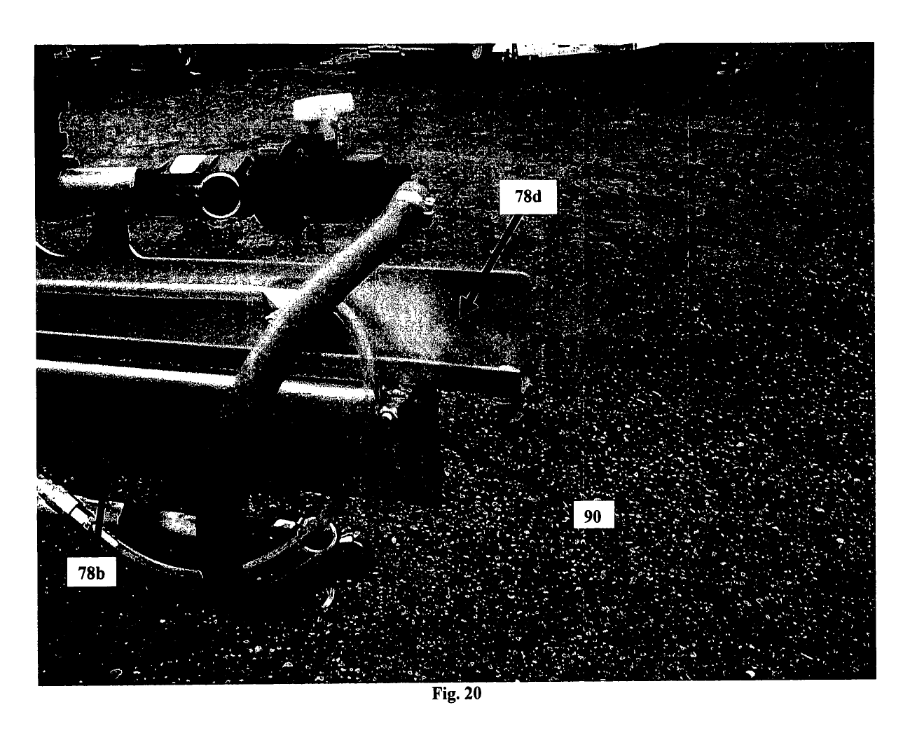

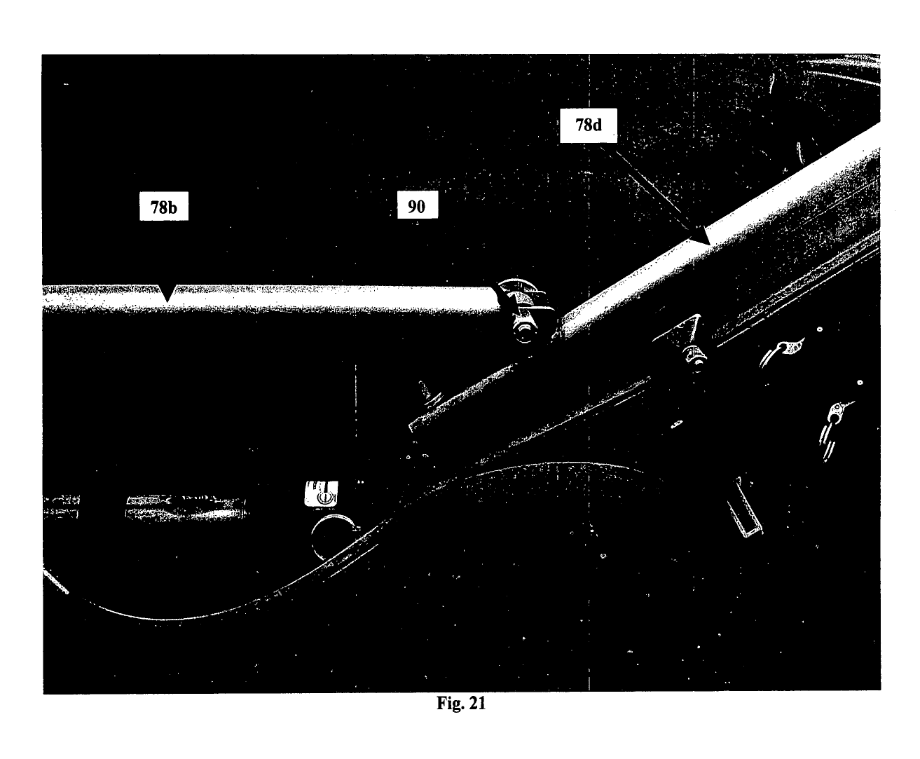

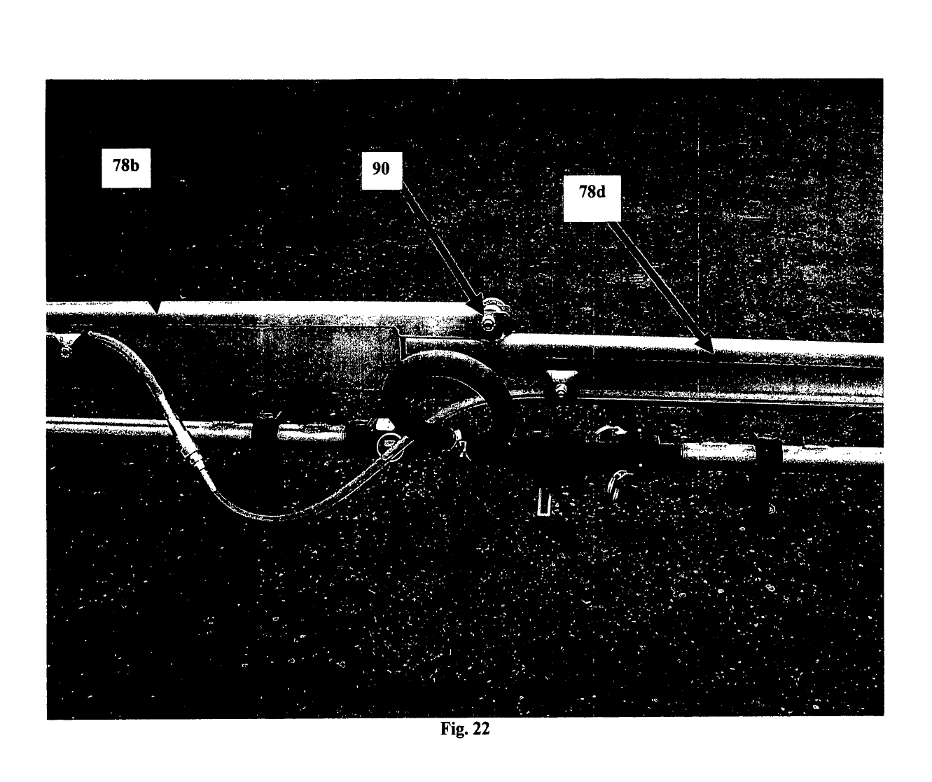

As shown in FIGS. 13-17 and 20-22, the fourth region 78d and fifth region 78e may be pivotally attached to the second region 78b, and a third region 78c, respectively. The attachment point may include a joint 90 that causes the fourth and fifth regions to pivot within a vertical plane between a stowed position (FIG. 20), a partially extended-position (FIG. 21), and a fully extended position (FIG. 22). Because the fourth and fifth regions extend the boom furthest from the vehicle, they also function to retain the marking nozzles 72 and 74, as shown in FIGS. 13-17.

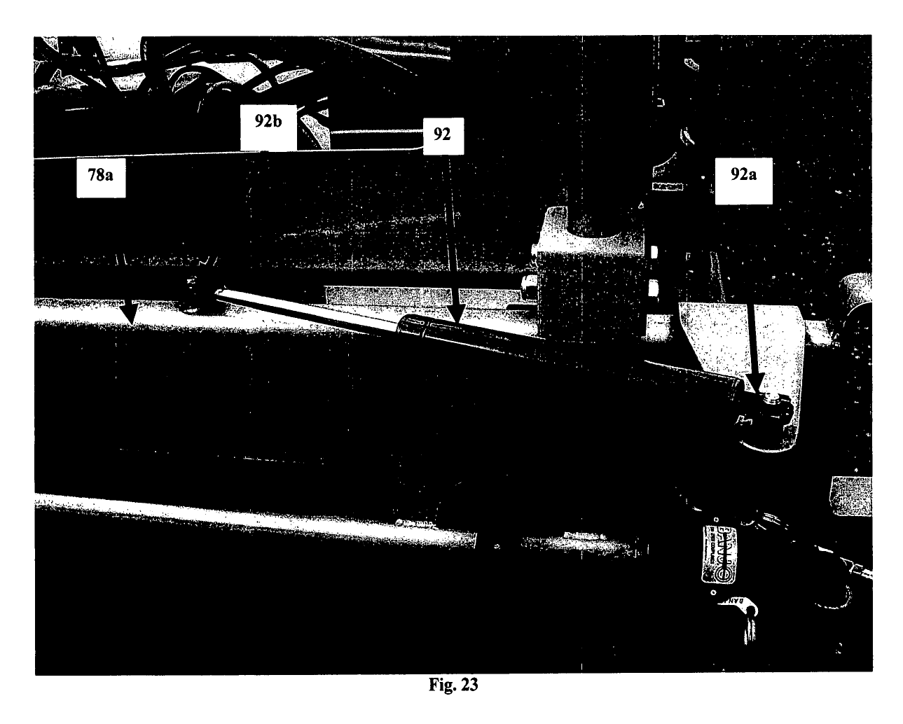

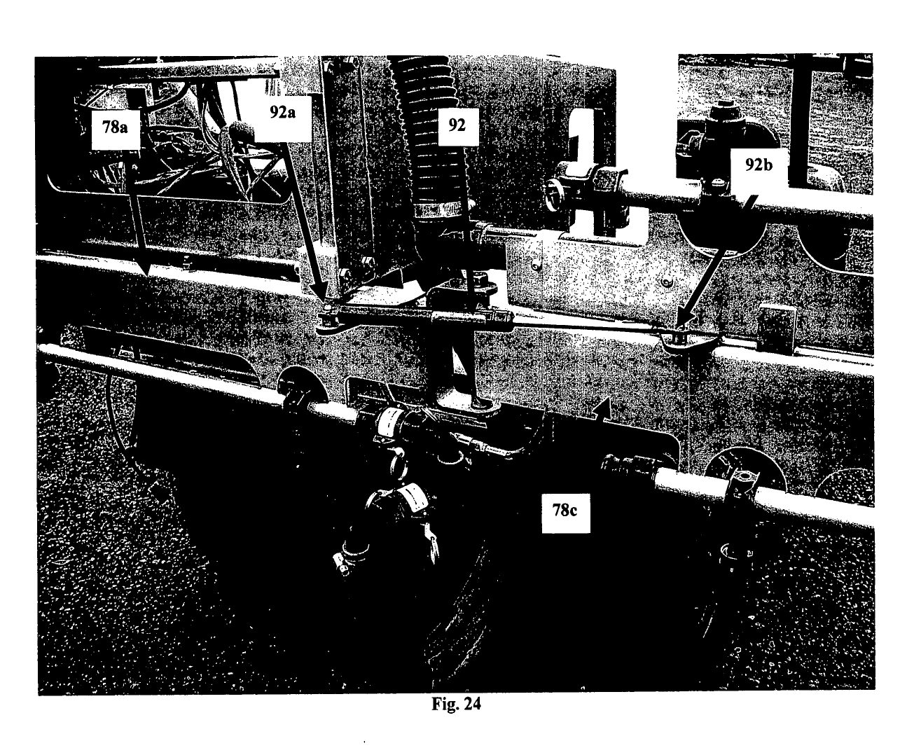

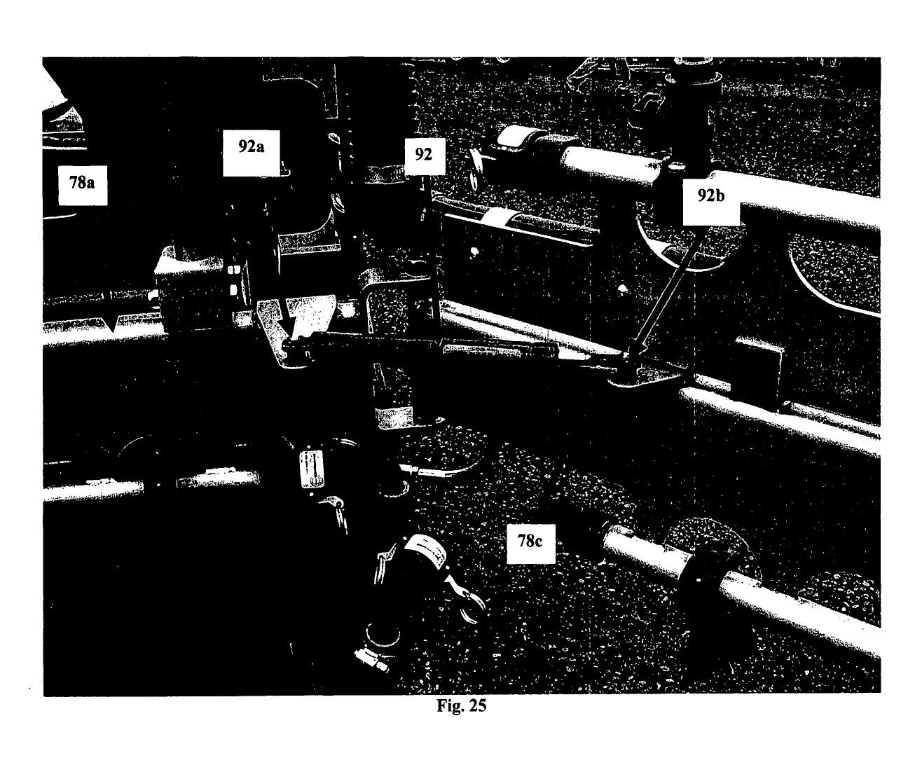

Each side of the boom may include a break-away mechanism that functions (1) to substantially retain the second region 78b and third regions 78c in the extended positions, and (2) to permit the second and third regions to slightly flex towards the rear of the vehicle when pressure is applied to the front of the boom. FIGS. 23-25 show a piston 92 for retaining the third region in the extended position (an identical piston may be included for the second region). The piston may be similar to a door piston with an equilibrium point caused by an internal biasing mechanism. A first end 92a of the piston may be fixedly attached to the first region. A second end 92b of the piston may be selectively attached to either the first region when it is inoperable for its functions (FIG. 23), or to the third region when it is operable for its function (FIG. 24). When pressure is applied to the front of the piston (i.e. from the front of the vehicle towards the rear of the vehicle), the piston slightly compresses, thereby allowing the third region to flex (FIG. 25). After the pressure is released, the piston biases the third region back into the fully extended position (FIG. 24). The break-away mechanism thereby provides some flexibility within the boom structure, in case an operator inadvertently causes the boom to collide with an object while driving in the forward direction.

This disclosure encompasses multiple distinct inventions with independent utility. While each of these inventions has been described in its best mode, numerous variations are contemplated. All novel and non-obvious combinations and subcombinations of the described and/or illustrated elements, features, functions, and properties should be recognized as being included within the scope of this disclosure. Applicant reserves the right to claim one or more of the inventions in any application related to this disclosure. Where the disclosure or claims recite “a” “a first” or “another” element, or the equivalent thereof, they should be interpreted to include one or more such elements, neither requiring nor excluding two or more such elements.

What is claimed is:

1. A sprayer system for spraying liquid to fall on a desired area of ground, comprising:
a reservoir for storing a liquid;
a pump adapted to draw the liquid from the reservoir;
at least one operative nozzle adapted to spray at least some of the liquid drawn from the reservoir by the pump onto the ground;
a valve adapted to vary continuously the amount of the drawn liquid being supplied by the pump to the nozzle;
a flow-rate meter adapted to continuously measure the amount of liquid being supplied by the pump to the nozzle; and
a controller operatively attached to the flow-rate meter and the valve, and including a user input for entering a constant value corresponding to a preselected amount of liquid to be evenly distributed by the sprayer system over a preselected area of the ground.

2. The system of claim 1, wherein the controller is constructed with a determiner for continuously determining the vehicle's rate of travel, a calculator for continuously calculating the amount of liquid that must be supplied to the nozzle based on the vehicle's rate of travel to distribute evenly the preselected amount of liquid over the preselected area of ground, a receiver for continuously receiving a signal from the flow-rate meter indicating the actual amount of liquid being supplied to the nozzle, a comparer for continuously comparing the amount of liquid that must be supplied to the actual amount of liquid being supplied, and an adjustor for automatically adjusting the valve to vary the actual amount of liquid being supplied so that it is equal to the amount of liquid that must be supplied.
